(19) United States
(12) Patent Application Publication
(10) Pub. No.: US 2024/0116701 A1
(43) Pub. Date: Apr. 11, 2024

(54) TRASH CAN WITH PICKUP INDICATOR

(71) Applicants: Norm Deschamps, Stayner (CA); Anna Payment, Stayner (CA)

(72) Inventors: Norm Deschamps, Stayner (CA); Anna Payment, Stayner (CA)

(21) Appl. No.: 17/962,467

(22) Filed: Oct. 8, 2022

(51) Int. Cl. B65F 1/12; B65F 1/16

(52) U.S. Cl. CPC B65F 1/12; B65F 1/1646; B65F 2001/1653; B65F 2210/168

(57) ABSTRACT

A trash can with an indicating means for visually showing that the trash can has been emptied or collected. The indicating means for trash pickup provides visual indication from remote distances that a trash can has been emptied. It is intended to eliminate trips to the trash can location to only find out that the trash has not been emptied yet. The indicating means is intended for use on a trash can with an attached lid that is permanently connected via a hinge. The trash can may include other accessories such as wheels, handles, and the like. The indicating means may be utilized on trash cans of varying sizes from small to large. As such, the use of any specific size of trash can or use of accessories is not intended to be a limiting factor of the present invention.

### FIELD OF THE INVENTION

This invention relates to fishing. More particularly, it relates to a device for lifting one or more netted fish to a user at an elevated venue.

### BACKGROUND

A waste container, also known as a dustbin, garbage can, and trash can is a type of container that is usually made from metal or plastic. The words “rubbish”, “basket” and “bin” are more common in British English usage; “trash” and “can” are more common in American English usage. “Garbage” may refer to food waste specifically (when distinguished from “trash”) or to municipal solid waste in general.

A waste collector, also known as a garbageman, trashman, is a person employed by a public or private enterprise to collect and dispose of municipal solid waste (refuse) and recyclables from residential, commercial, industrial, or other collection sites for further processing and waste disposal. Specialized waste collection vehicles (also known as garbage trucks in the US) featuring an array of automated functions are often deployed to assist waste collectors in reducing collection and transport time and for protection from exposure.

Curbside collection is a service provided to households, typically in urban and suburban areas, of collecting and disposing of household waste and recyclables. It is usually accomplished by personnel using specially built vehicles to pick up household waste in containers that are acceptable to, or prescribed by, the municipality and are placed on the curb.

Curbside collection is today often referred to as a strategy of local authorities to collect recyclable items from the consumer. Curbside collection is considered a low-risk strategy to reduce waste volumes and increase the recycling rates. Recyclable materials are typically collected in large wheelie bins, plastic bags, or small open, colored plastic boxes, specifically designated for content.

Curbside collection of recyclable resources is aimed to recover purer waste streams with higher market value than by other collection methods. If the household residents incorrectly separate the recyclable materials, or put the wrong items in the recycling bin, the whole vehicle load of recycling will have to be rejected and sent to landfill or incineration if it is deemed to be contaminated.

Curbside collection and household recycling schemes are also being used as tools by many local authorities to increase the public's awareness of their waste production.

With the trash containers that exist today for curbside pickup, there is no way of knowing if the trash collection has occurred by the garbageman without physically going to the trash container and viewing it possibly causing multiple trips to the trash container. This can be cumbersome if the container is not located close by.

Accordingly, and in light of the foregoing, it would be desirable to have a way to know if the trash collection has occurred. A device could be attached to the trash container providing an inexpensive way to add on a visual verification with use of a flag from remote distances that trash has been picked up. This would also eliminate the need to visit the trash can multiple times.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the indicating means for trash pickup 10, according to the preferred embodiment of the present invention;

FIG. 2 is a side view of the indicating means for trash pickup 10 on a trash can 15 in a stored or retracted state, according to the preferred embodiment of the present invention;

FIG. 3 is a side view of the indicating means for trash pickup 10 on a trash can 15 in an active or deployed state, according to the preferred embodiment of the present invention; and,

FIG. 4 is a sectional view of the indicating means for trash pickup 10, as seen along a line II-II, as shown in FIG. 3, according to the preferred embodiment of the present invention.

### DESCRIPTIVE KEY

10 indicating means for trash pickup
15 trash can
20 attached lid
25 hinge
30 wheel
35 handle
40 lid travel path “l”
45 flag
50 shaft
55 first post
60 connecting shaft
65 second shaft
70 upper rim
75 flag securing travel path “f”
80 clip
85 flag deployment travel path “a”
90 spring
95 rod
100 retaining flange
105 inner retainer
110 outer retainer
115 repelling force “r”

### DESCRIPTION OF THE PREFERRED EMBODIMENT

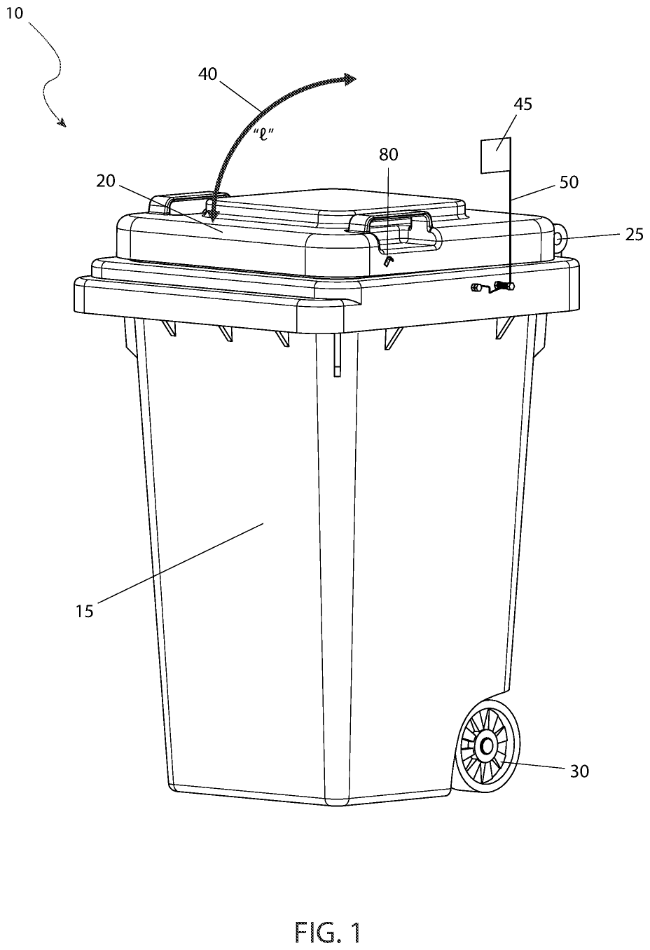

The best mode for carrying out the invention is presented in terms of its preferred embodiment, herein depicted within FIGS. 1 through 4. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### DETAILED DESCRIPTION OF THE FIGURES

Referring now to FIG. 1, a perspective view of the indicating means for trash pickup 10, according to the preferred embodiment of the present invention is disclosed. The indicating means for trash pickup (herein also described as the “indicating means”) 10, provides visual indication from remote distances that a trash can has been emptied. It is intended to eliminate trips to the trash can location to only find out that the trash has not been emptied yet. The indicating means 10 is intended for use on a trash can 15 with an attached lid 20 that is permanently connected via a hinge 25. The trash can 15 may include other accessories such as wheels 30, handles 35, and the like. The indicating means 10 may be utilized on trash cans 15 of varying sizes from small to large. As such, the use of any specific size of trash can 15 or use of accessories is not intended to be a limiting factor of the present invention.

The trash can 15 would preferably be emptied by a municipal trash service using an automated lifting and emptying arm. The attached lid 20 is intended to open and close along a lid travel path “l” 40 as expected. The indicating means 10 provides for a flag 45 mounted atop a shaft 50. It is envisioned that flag 45 would be provided in a high contrast color such as yellow, red, orange, fluorescent colors, and the like such that it is visible for distances of five hundred feet (500 ft.) or more. The size of the flag 45 is envisioned to be approximately four square inches (4 in.²) while the length of the shaft 50 is envisioned to be approximately eighteen (18 in.), for purposes of illustration. However, the specific size of the flag 45 and the shaft 50 is not intended to be a limiting factor of the present invention.

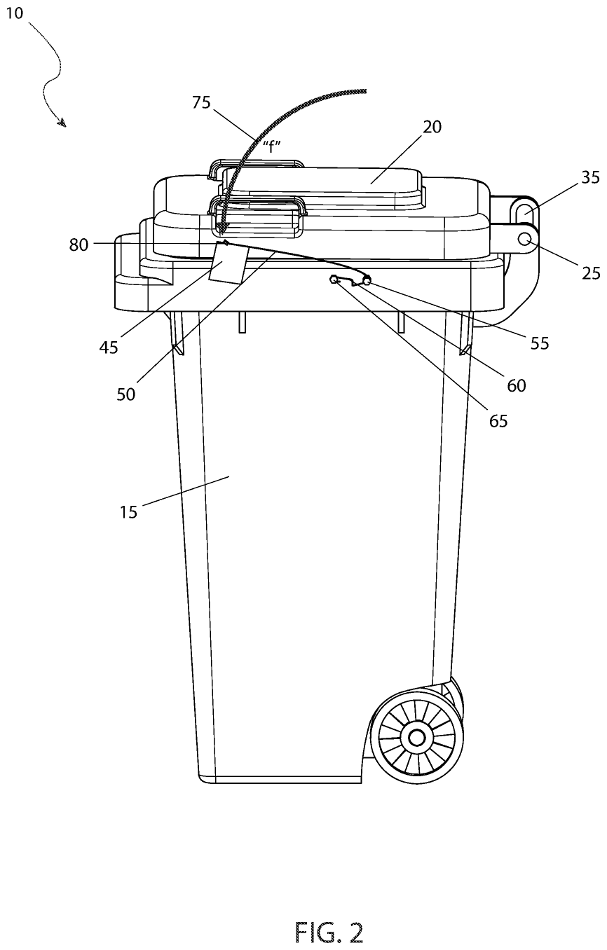

Referring next to FIG. 2, a side view of the indicating means 10 on a trash can 15 in a stored or retracted state, according to the preferred embodiment of the present invention is depicted. The attached lid 20 is closed upon the trash can 15 as is found in a normal state. The shaft 50 terminates at its lower end at a first post 55. A connecting shaft 60 then provides a mechanical connection to a second shaft 65. Both the first post 55 and the second shaft 65 are connected to an upper rim 70 of the trash can 15. Further detail on the first post 55, the connecting shaft 60 and the second shaft 65 will be provided herein below.

When the trash can 15 is full and is placed at a curbside location for pickup, the user will move the flag 45 and shaft 50 from an upright position (as shown in FIG. 1), along a flag securing travel path “f” 75 and secure the shaft 50 under a clip 80. The clip 80 is permanently connected to the attached lid 20. The configuration as shown in FIG. 2 is that what would be experienced while the trash can 15 is waiting to be emptied by a municipal refuse truck.

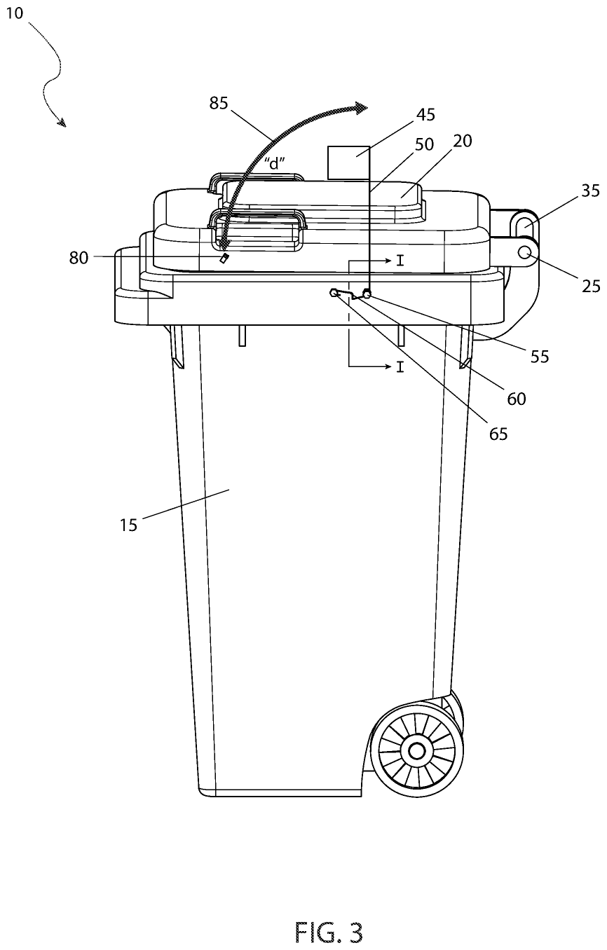

Referring now to FIG. 3, a side view of the indicating means 10 on a trash can 15 in an active or deployed state, according to the preferred embodiment of the present invention is shown. The attached lid 20 is closed upon the trash can 15 as is found in a normal state, such as after the trash can 15 has been emptied by a municipal refuse truck. The shaft 50, as well as the flag 45, is disengaged from the clip 80, as the attached lid 20 opens via the hinge 25, along the lid travel path “l” 40 (as shown in FIG. 1), during the municipal refuse truck dumping cycle. The shaft 50 remains terminates at its lower end at the first post 55, with the connecting shaft 60 providing a mechanical connection to a second shaft 65. When the trash can 15 has been emptied and returned to its curbside location, the user (home resident) will be able to visually discern the flag 45 in its upright and deployed position as shown in FIG. 3, signaling that a trip to the curbside location to retrieve the trash can 15 is now warranted. The flag 45 and shaft 50 may remain in the upright and deployed position (as shown in FIG. 3) until the next refuse pickup cycle, where once again the first post 55 is secured under the clip 80 once at the curbside location (as shown in FIG. 3).

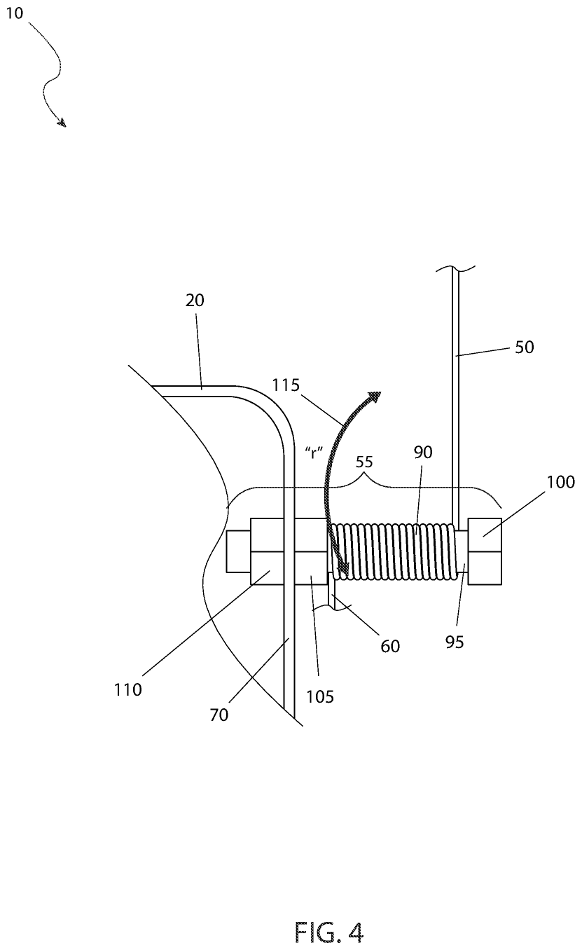

Referring finally to FIG. 4, a sectional view of the indicating means 10, as seen along a line II-II, as shown in FIG. 3, according to the preferred embodiment of the present invention is disclosed. The shaft 50 transitions to a spring 90, either as an integral part of the shaft 50, or as a separate component. Likewise, the connecting shaft 60 may be an integral part of the spring 90 or be provided as a separate component. The first post 55 consists of a rod 95, provided with a retaining flange 100 at its outer end. The spring 90 is wound about the rod 95 as shown. The inner end of the rod 95 is mechanically coupled to the upper rim 70, via use of an inner retainer 105 and an outer retainer 110. The rod 95 and the retaining flange 100 may be interpreted as a bolt, while the inner retainer 105 and the outer retainer 110 may be a nut. The specific configuration of the first post 55 is not intended to be a limiting factor of the present invention. It is noted that the configuration of the second shaft 65 (as shown in FIG. 2) is similar in nature to that of the first post 55 as shown. The configuration of the spring 90 produces a repelling force “r” 115 between shaft 50 and the connecting shaft 60 resulting in the flag 45 remaining in an upright position (as shown in FIGS. 1 and 3) when not restrained by the clip 80 (as shown in FIG. 2).

### Operation of the Preferred Embodiment

The preferred embodiment of the present invention can be utilized by the common user in a simple and effortless manner with little or no training. It is envisioned that the indicating means 10 would be constructed in general accordance with FIG. 1 through FIG. 4. The user would procure the indicating means 10 from conventional procurement channels such as hardware stores, home improvement stores, discount stores, mechanical supply houses, mail order and internet supply houses and the like. It is envisioned that the teachings of the indicating means 10 can be provided as an integral component of a new trash can 15 or provided as an aftermarket add-on device for installation on an existing trash can 15.

In the case of aftermarket installation, the user would drill necessary holes in the upper rim 70 for the first post 55 and the second shaft 65; the spring 90, along with the attached shaft 50 and second shaft 65 would be positioned upon the first post 55 and secured in place with the inner retainer 105 and the outer retainer 110; the second shaft 65 would be installed in a similar manner; the connecting shaft 60 is then secured to the second shaft 65; and the clip 80 is secured to the attached lid 20. At this point in time, the indicating means 10 is ready for use.

During utilization of the indicating means 10, the following procedure would be initiated: according to the refuse pickup schedule, the trash can 15 is placed at a curbside location for pickup, the user (home resident) will move the flag 45 and shaft 50 from an upright position (as shown in FIG. 1), along the flag securing travel path “f” 75, and secure the shaft 50 under a clip 80; the flag 45 remains under the clip 80 until the trash can 15 is emptied, preferably by an automated arm on a municipal refuse trash vehicle, whereupon the attached lid 20, traveling along the lid travel path “l” 40, releases the shaft 50 and the flag 45.

When the trash can 15 has been emptied and returned to its curbside location, the user will be able to visually discern the flag 45 in its upright and deployed position, signaling that a trip to the curbside location to retrieve the trash can 15 is now warranted; the flag 45 and shaft 50 may remain in the upright and deployed position until the next refuse pickup cycle, where once again the first post 55 is secured under the clip 80 once at the curbside location in a repeating and cyclical cycle.

The features of the indicating means 10 provide the following benefits: providing an inexpensive purchase either as a component of a new trash can 15 or as an add-on kit for an existing trash can 15; long life, quality components, allows for visual verification that refuse pickup has occurred, elimination of unnecessary trips to the curbside location, and retrieval of the trash can 15 as soon as possible after pickup to prevent loss of the trash can 15 due to wind and weather conditions.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A trash can for visually indicating whether trash in the trash can has been collected, the trash can consisting of:
a trash can;
an attached lid, the attached lid being coupled to the trash can by a hinge;
one or more wheels, each of the wheels being coupled to the trash can;
a handle, the hand being coupled to the trash can; and
an indicating means for trash pickup, the indicating means for trash pickup being attached to the lid.

2. The trash can according to claim 1, wherein the attached lid opens and closes along a lid travel path.

3. The trash can according to claim 1, wherein the indicating means comprises a flag, the flag being mounted upon a first shaft.

4. The trash can according to claim 3, wherein the flag has a width of four (4) inches.

5. The trash can according to claim 3, wherein the flag has a length of four (4) inches.

6. The trash can according to claim 3, wherein the first shaft has a length of eighteen (18) inches.

7. The trash can according to claim 3, wherein the flag is a red.

8. The trash can according to claim 3, wherein the flag is green.

9. The trash can according to claim 3, wherein the flag is orange.

10. The trash can according to claim 3, wherein the flag is a fluorescent color.

11. The trash can according to claim 3, wherein the flag is visible for at least five-hundred (500) feet.

12. The trash can according to claim 3, wherein the shaft has a lower end, the lower end of the shaft terminates at a first post.

13. The trash can according to claim 12, wherein the shaft has a connecting shaft, the connection shaft having a mechanical connection to a second shaft.

14. The trash can according to claim 13, wherein the first shaft and the second shaft are coupled to a an upper rim of the trash can.

15. The trash can according to claim 13, wherein when the trash can is full, the flag and first shaft are configured in an upright position, the first shaft being secured under a clip.

16. The trash can according to claim 15, wherein the clip is permanently connected to the attached lid.

17. The trash can according to claim 16, wherein when the trash can has been emptied, shaft and the flag are disengaged from the clip when the attached lid opens via the hinge.

18. The trash can according to claim 17, wherein the flag has been returned to an upright position.

19. The trash can according to claim 1, wherein the flag is visible to indicate the emptying of the trash can.

20. The trash can according to claim 3, wherein the shaft is a spring.
